(19) United States
(12) Patent Application Publication
(10) Pub. No.: US 2003/0077932 A1
(43) Pub. Date: Apr. 24, 2003

(54) Floating blind mate interface for automatic test system

(76) Inventor: David W. Lewinnek, Cambridge, MA (US)

Correspondence Address: Legal Department, Teradyne, Inc., 321 Harrison Avenue, Boston, MA, 02118, US

(21) Appl. No.: 10/047,513

(22) Filed: Oct. 22, 2001

(51) Int. Cl. H01R 13/64

(52) U.S. Cl. 439/246

(57) ABSTRACT

An interface for making blind-mate connections between a test head of an automatic test system and a device interface board (DIB) includes floating brackets that are individually and compliantly coupled to the test head. The floating brackets each include a plurality of blind-mate connectors and alignment pins for engaging alignment holes within the DIB. When the DIB is pulled down against the test head, the floating brackets can individually move in compliance with applied forces to align the blind-mate connectors with complementary connectors on the DIB.

### CROSS-REFERENCES TO RELATED APPLICATIONS

Not Applicable.

### STATEMENT REGARDING FEDERALLY SPONSORED RESEARCH OR DEVELOPMENT

Not Applicable.

### Reference to Microfiche Appendix

Not Applicable

### BACKGROUND OF THE INVENTION

1. Field of the Invention

This invention relates generally to electrical interfaces for making large numbers of electrical connections simultaneously and quickly, and, more particularly, to using such electrical interfaces for making connections between different portions of an automatic system for testing electronic devices.

### DESCRIPTION OF RELATED ART INCLUDING INFORMATION DISCLOSED UNDER 37 C.F.R. 1.97 AND 1.98

Automatic test equipment (ATE) for testing integrated circuits includes two principle components—a tester and a peripheral. The tester includes electronic hardware and software for exercising devices under test (“DUTs”), to ensure that the devices work properly before they are shipped to customers. The peripheral includes mechanisms for automatically transferring DUTs to a test site, in rapid succession for testing by the tester, and for transferring the DUTs away from the test site once testing is complete. By operating together, the tester and the peripheral can test large numbers of devices very quickly.

At the interface between the tester and the peripheral lies a device interface board, or “DIB.” Different DIBs are generally used for testing different types of electronic devices, so DIBs are designed to be easily removable and interchangeable.

In a normal testing arrangement, a DIB is attached either to the peripheral or to a portion of the tester called the “test head.” A manipulator physically positions the test head in alignment with the peripheral and causes the test head and peripheral to mechanically “dock.” The act of docking sandwiches the DIB between the test head and the peripheral and allows electrical signals to pass between the tester and DUTs for testing.

Test systems generally convey electrical signals between the test head and the DIB using blind-mate connectors. As known to those skilled in the art, “blind-mate” describes a connection scheme in which two parts of a connector, such as a male part and a female part, can be mated by virtue of their positioning and alignment, generally by pressing together two separable portions of an assembly. Blind-mate connectors are often used in modular electronic systems, in areas that are enclosed or inaccessible. They are generally designed to overcome slight misalignments between their mating parts and to automatically seat themselves as their parts come together. In automatic test equipment, blind-mate pogo pins generally extend from the test head to mate with conductive pads on the DIB. In addition, blind-mate RF connectors may also extend from the test head, for mating with complementary blind-mate RF connectors on the DIB.

Test systems customarily provide coarse alignment mechanisms for aligning the DIB with the test head. For example, in the Tiger test system, which is manufactured by Teradyne, Inc., of Boston, Mass., the DIB includes alignment bushings for engaging alignment pins on a peripheral. Alignment pins also extend from the test head, for engaging bushings on the peripheral. First the DIB is attached to the peripheral; then the peripheral is docked with the test head. By aligning the DIB with the peripheral and then aligning the peripheral with the test head, the DIB becomes coarsely aligned with the test head. Depending upon alignment accuracy, as well as the dimensions and tolerances of the blind-mate connectors, this coarse alignment may be adequate to ensure that the blind-mate connectors align.

Increasingly, ATE manufactures are designing test heads with smaller connectors, and these connectors are being more closely spaced than before. As a result, the coarse alignment between the test head and DIB may not be adequate to ensure that the blind-mate connectors at the interface mate.

One prior approach to overcoming this problem has been to provide the connectors with enough play to individually overcome misalignments. FIGS. 1 and 2 show an example of this approach. A test head includes an array 100 of connector blocks 110 for holding blind-mate connectors. The connector blocks 110 retain accurate positions, relative to the test head, using alignment pins 220 and 222. Blind-mate pogo pins (not shown in FIG. 2) extend from holes 212 of a pin housing 214. Blind-mate RF connectors 216 extend from individual holes 218 formed within L-shaped supports 210 of the connector blocks 110. The holes 218 are oversized in relation to the RF connectors 216. The extra space around each connector allows the RF connectors 216 to move and seat themselves when mating with connectors on the DIB.

Although this approach works well for small misalignments, it fails when the misalignments become large in relation to the connector size and spacing. We have recognized that even highly precise alignment between the test head and the DIB does not ensure that all the connectors will align. The test head and the DIB are large assemblies constructed of many parts. Alignment errors accumulate across these large assemblies and between their constituent parts to misalign the connectors. What is needed, therefore, is a better way of aligning blind-mate connectors to account for these and other misalignments.

### BRIEF SUMMARY OF THE INVENTION

With the foregoing background in mind, it is an object of the invention to align blind mate connectors at an interface between different portions of a test system.

To achieve the foregoing object, as well as other objectives and advantages, an interface for making blind-mate connections between a first portion of a test system and a second portion of a test system includes a plurality of floating brackets individually and compliantly coupled to the first portion of the test system. Blind-mate connectors are attached to each floating bracket, for mating with complementary blind-mate connectors attached to the second portion of the test system. In compliance with applied mating forces, the floating brackets are individually moveable with respect to the first portion of the test system, for aligning and mating the blind-mate connectors of the first portion of the test system with the blind-mate connectors of the second portion of the test system.

### BRIEF DESCRIPTION OF THE SEVERAL VIEWS OF THE DRAWINGS

Additional objects, advantages, and novel features of the invention will become apparent from a consideration of the ensuing description and drawings, in which—

FIG. 1 is an isometric view of an array of blind-mate connectors used in a test head of an automatic test system, according the prior art;

FIG. 2 is an isometric view of a single connector block from the array of FIG. 1;

FIG. 3 is an isometric view of a connector block in accordance with the invention;

FIG. 4 is an exploded, isometric view of the connector block of FIG. 3;

FIG. 5 is an isometric view of a mating block, for use on a DIB, for mating with the connector block of FIGS. 4 and 5; and

FIG. 6 is an isometric view of a device interface board (DIB), and a portion of an array of blind-mate connectors with which the DIB mates.

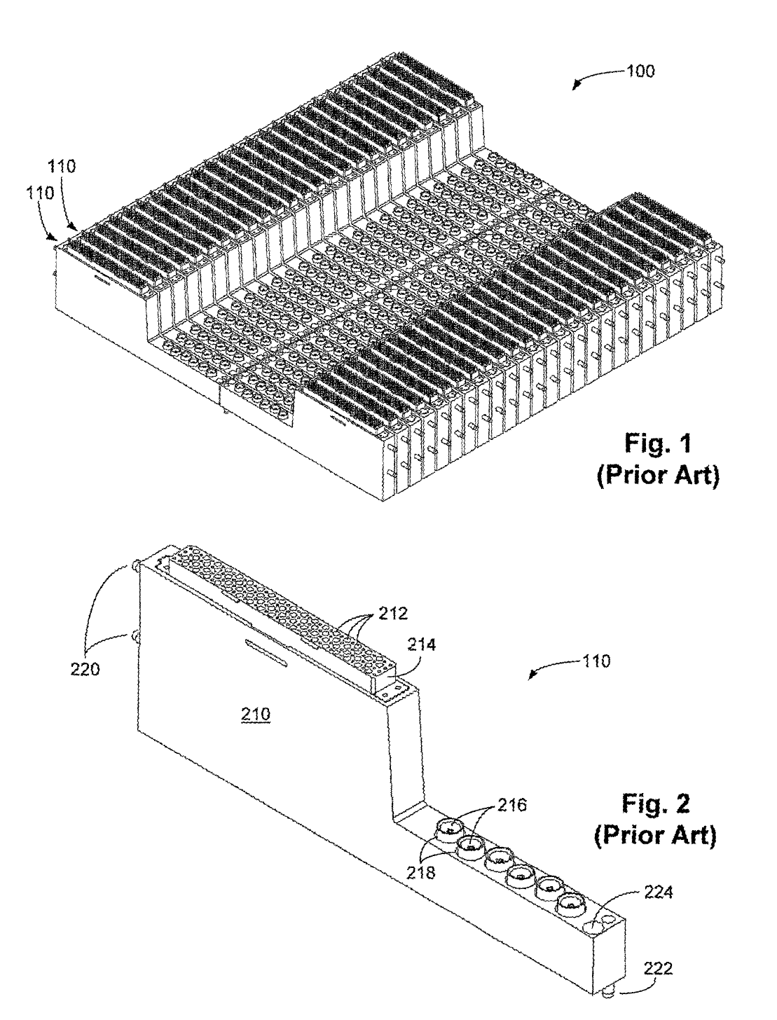

### DETAILED DESCRIPTION OF THE INVENTION

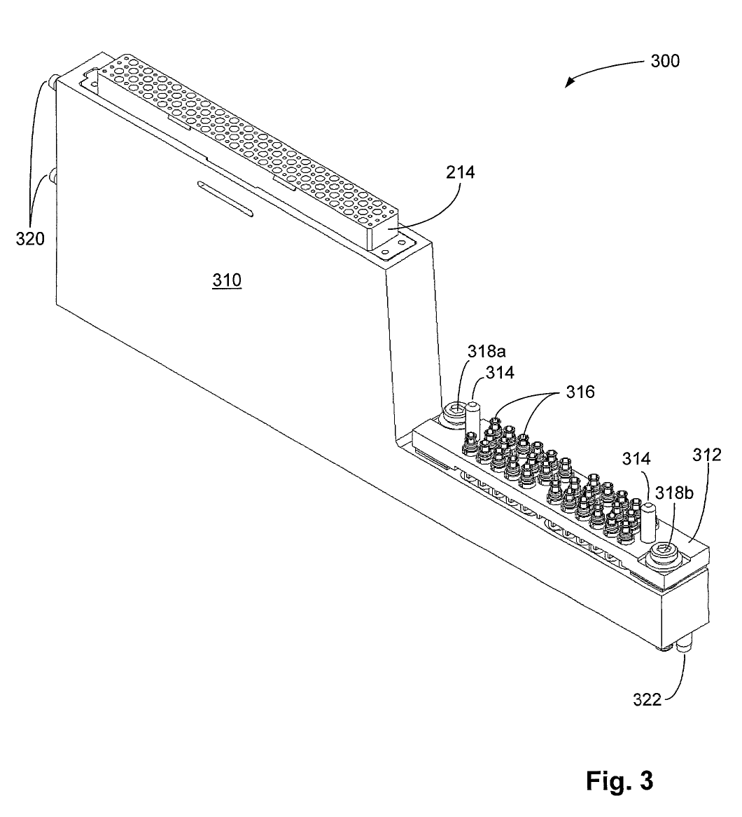

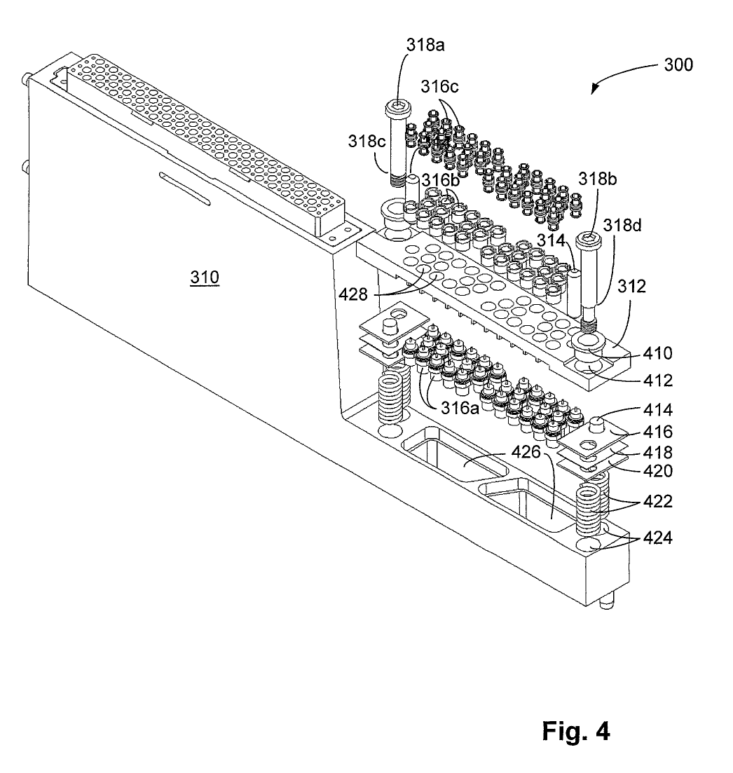

FIGS. 3 and 4 show a connector block 300 in accordance with the invention. The connector block 300 is similar in many respects to the connector block 110 of FIG. 2, and preferably can be used in place of the connector block 110. Like the connector block 110, the connector block 300 has an L-shaped support 310, a pogo-pin housing 214 (pins not shown), and alignment pins 320 and 322 for aligning the connector block 110 within the test head. The manner of providing RF connectors on connector block 300 differs markedly, however, from the manner of providing them on the connector block 110.

In contrast with the prior connector block 110, wherein the RF connectors 216 are mounted to the support 210, the RF connectors 316 of the connector block 300 are instead mounted to a floating bracket 312. The floating bracket 312 is compliantly mounted to the support 310 of the connector block 300 via cylindrical fasteners, such as screws 318a and 318b. The screws 318a and 318b pass through holes 412 in the floating bracket 312. The screw 318a preferably extends into a hole 424 of the support and is captured within a threaded portion thereof (not shown). The screw 318b preferably extends through the support 310, where it is captured in a threaded region of another component (not shown) below the support.

Preferably, the screws also pass through shoulder washers 410 disposed within the holes 412. The shoulder washers 410 have an inner diameter that is approximately 3 mm larger than the diameters of the necks of the screws 318a and 318b. This mismatch in diameter allows the floating bracket 312 to move along a horizontal plane relative to the support 310 through a substantial range of compliance. Four springs 422 are disposed within holes 424 of the support 310 to bias the floating bracket 312 in an upper position relative to the support 310. Two of these springs are preferably positioned concentrically around the screws 318a and 318b, and two are positioned around pins 414. The pins 414 reside within holes 424, where they keep the springs vertically oriented. The screws 318a and 318b respectively have shoulders 318c and 318d that abut corresponding shoulders (not shown) within the holes 424, to define bottom-most positions to which the screws can be advanced. With the screws 318a and 318b advanced to these bottom-most positions, the floating bracket 312 can be made to move through a vertical compliance range on the springs 422. The springs 422 are preferably positioned and specified to provide enough upward force to overcome the insertion force of the RF connectors 316 with their counterparts on the DIB, while still allowing vertically compliant movement in response to docking forces.

The floating bracket 312 is preferably made of steel, and the support 310 is preferably made of aluminum. To reduce ground loops and interference within the test system in which it is used, the floating bracket 312 is preferably electrically insulated from the support 310. Insulating sheets 416, preferably made of Delrin®, are placed between the floating bracket 312 and the springs 422 (Delrin® is a registered trademark of E. I. du Pont de Nemours and Company). To reduce wear on the insulating sheets, steel sheets 418 are preferably affixed to the bottoms of the insulating sheets 414 using sheets 416 of double-stick tape. Thus, the Delrin® contacts the floating bracket 312, but the springs 422 rub against the steel. The shoulder washers 410 and the pins 414 are preferably made of insulative plastic.

Unlike the prior RF connectors 216, which are individually floated, the RF connectors 316 of the connector block 300 are floated as a group. A pair of alignment pins 314 extends from the floating bracket 312. The alignment pins 314 are preferably steel and are press fit or screwed into the floating bracket 312. The alignment pins 314 are positioned and arranged to engage alignment holes adjacent to mating connectors on the DIB. The alignment pins and holes have beveled or rounded ends, which allow the pins to seat themselves within the holes when the DIB is pressed against the test head. As the alignment pins seat themselves, the floating brackets compliantly move into precise alignment with the DIB, and the RF connectors 316 accurately mate.

The floating brackets 312 allow for initial horizontal misalignments of approximately±1.5 mm. Individual connectors simply cannot provide this much play at the connector sizes and spacing desired. Because the RF connectors are aligned as groups, however, their misalignments can be overcome without requiring significant additional space.

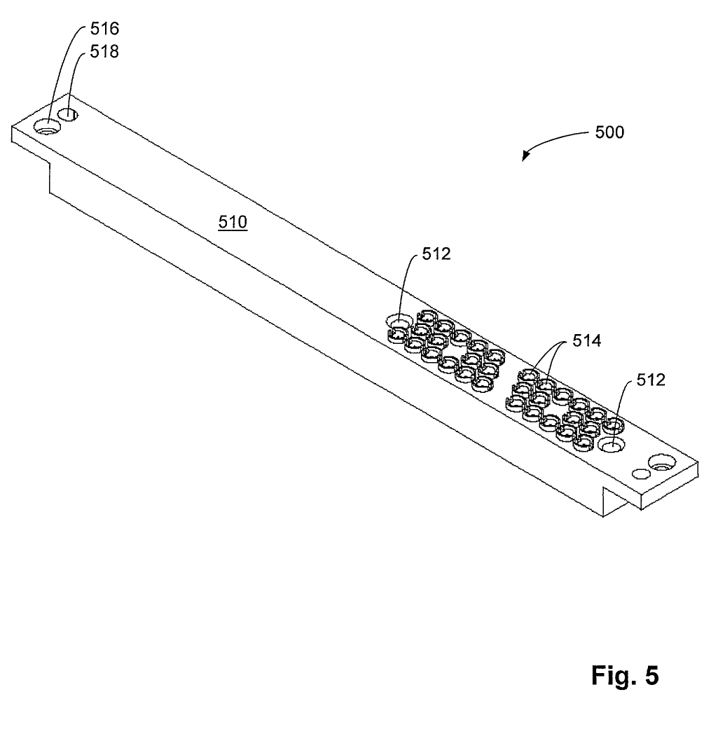

FIG. 5 shows an example of a mating bracket 500. Mating brackets 500 are installed within a DIB and arranged to engage with corresponding connecting blocks 300.

Each mating bracket 500 includes a support 510 and RF connectors 514. Alignment holes 512 are formed within the support 510 for receiving alignment pins from the corresponding floating bracket 312.

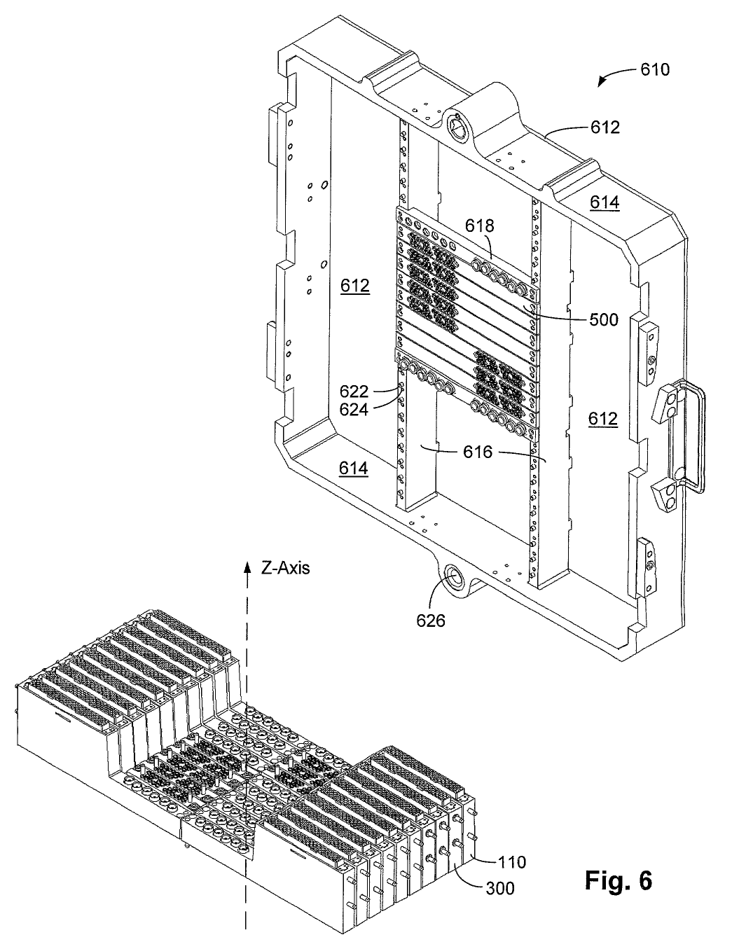

FIG. 6 shows a DIB 610 positioned above a partial array of connector blocks on a test head (and rotated to reveal its bottom surface). The DIB 610 includes a printed circuit board 612 and a stiffener 614 having a pair of internal supports 616. The printed circuit board 612 includes conductive pads (not shown) for making contact with pogo pins extending from the connector blocks when the DIB is mated with the test head. Mating brackets 500 are mounted to the DIB 610 between the internal supports 616. The mating brackets 500 include alignment holes 518 (see FIG. 5) for receiving alignment pins 622 extending from the internal supports 616. They also include holes 516 for receiving screws, which fasten the mating brackets 500 to the internal supports 616. The mating brackets 500 are thus held firmly in place, with substantially no compliance, within the DIB 610.

In the preferred embodiment, the RF connectors 316 and 514 are SSMP coaxial connectors. These connectors are available from Connecting Devices Incorporated (CDI) of Long Beach, Calif. As shown in FIG. 4, the RF connectors 316 on the connector block 300 each consist of three parts: a male cable termination 316a; a threaded cap 316b; and a female-female “bullet” 316c. Coaxial cables (not shown) attach to bottoms of the cable terminations 316a and extend through holes 426 in the support 310, where the cables connect to internal portions of the test head. The tops of the cable terminations 316a enter holes 428 in the floating bracket 312. The threaded caps 316b are screwed to the tops of the cable terminations 316a to hold them firmly to the floating bracket 312. Female-female bullets 316c are pressed into the tops of the threaded caps 316b, where they make electrical contact with the male portions of the cable terminations 316a. A lip at the outer circumference of each of the female-female bullets 316a engages a recessed detent (not shown) within each of the corresponding threaded caps 316a. The detents tightly retain the bullets within the threaded caps.

The RF connectors 514 on the mating bracket 500 are similar to the RF connectors 316 on the connector block 300. They each include a male cable termination and a threaded cap (not shown separately). Significantly, however, the threaded caps of the connectors 514 do not contain interior detents. Therefore, the connectors 514 retain the bullets less strongly than do the connectors 316, causing the bullets to remain with the test head when the test head and the DIB are separated.

The floating blind-mate connection scheme described herein allows large numbers of blind-mate connectors to be aligned as groups, and thus provides a great deal of play for overcoming misalignments while requiring little additional space. This scheme allows extremely small connectors to be closely spaced while maintaining accurate alignment. This connection scheme is applicable in a number of areas. In particular, it is useful for conveying RF signals to a DIB. It is also useful for conveying high frequency digital signals, such as those used for high frequency serial testing.

Alternatives

Having described one embodiment, numerous alternative embodiments or variations can be made. The connection scheme described herein is presented in relation to the interface between a test head and a DIB. This is merely an example, however. The connection scheme can be used wherever different separable portions of a test system come together. At some time in the future, testers may be designed as integrated assemblies without separate test heads. In these instances, the invention could reside at the interface between the integrated tester and the DIB.

The floating brackets have been described in connection with the test head rather than the DIB. This arrangement is more economical than the reverse arrangement—with the floating brackets attached to the DIB—because many different DIBs can be used with any given test system. Including the more complex hardware with the test head thus reduces overall cost. This design choice is not essential to the invention, however. Alternatively, the floating brackets could be provided on the DIBs, and the test head could employ fixed brackets. It is it also not strictly essential that the mating brackets be fixed. They could be made to float as well. Such an arrangement would be economically ill advised, however, as it would involve a duplication of complexity and expense, which could likely be avoided.

As described herein, a different mating bracket is provided for each floating bracket. The invention does not require this direct correspondence, however. Alternatively, larger mating brackets could be used for engaging multiple floating brackets, or a single panel could be used for engaging all of the floating brackets.

As described herein, the floating brackets include alignment pins for engaging alignment holes within the mating brackets. This could certainly be reversed, however, with the alignment pins extending from the mating brackets for engaging alignment holes within the floating brackets.

The floating brackets 312 are shown and described as attaching to the supports 310 of the connector blocks using screws 318a and 318b. However, fasteners other than screws could be used for attaching the floating brackets to the supports. For example, pins and E-clips could be used.

Each of these alternatives and variations, as well as others, has been contemplated by the inventors and is intended to fall within the scope of the instant invention. It should be understood, therefore, that the foregoing description is by way of example, and the invention should be limited only by the spirit and scope of the appended claims.

What is claimed is:

1. An interface for making blind-mate connections between a first portion of a test system and a second portion of a test system, comprising:
a plurality of floating brackets, each floating bracket being individually and compliantly connected to the first portion of the test system and including a plurality of blind-mate connectors,
wherein the plurality of blind-mate connectors is positioned and arranged for making electrical connections with a plurality of complementary blind-mate connectors attached to the second portion of the test system.

2. An interface as recited in claim 1, wherein each of the plurality of floating brackets includes an alignment mechanism for aligning the respective floating bracket with the second portion of the test system.

3. An interface as recited in claim 3, wherein the second portion of the test system includes a complementary alignment mechanism for engaging the alignment mechanism of each of the plurality of floating brackets.

4. An interface as recited in claim 3, wherein the alignment mechanism includes at least one of an alignment pin and an alignment hole.

5. An interface as recited in claim 1, wherein each of the plurality of floating brackets includes a plurality of holes for retaining each of the plurality of blind-mate connectors in a substantially fixed position relative to the floating bracket.

6. An interface as recited in claim 1, wherein the second portion of the test system includes a plurality of holes for retaining each of the plurality of complementary blind-mate connectors.

7. An interface as recited in claim 6, wherein the second portion of the test system includes a plurality of mating brackets each positioned and arranged to engage a different one of the plurality of floating brackets when the first portion of the test system is mated with the second portion of the test system.

8. An interface as recited in claim 7, wherein each of the plurality of mating brackets is substantially non-compliantly coupled to the second portion of the test system.

9. An interface as recited in claim 1, wherein the test system includes a coarse alignment mechanism for aligning the first portion of the test system with the second portion of the test system.

10. An interface as recited in claim 9, wherein each of the plurality of floating brackets includes an alignment mechanism for aligning the floating bracket with the second portion of the test system.

11. An interface as recited in claim 1, wherein the first portion of the test system is one of a test head and a device interface board, and the second portion of the test system is the other of the test head and the device interface board.

12. An interface as recited in claim 1, wherein the first portion of the test system is one of a tester and a device interface board and the second portion of the test system is the other of the tester and the device interface board.

13. An interface as recited in claim 1, wherein the plurality of blind-mate connectors for each of the floating brackets is a plurality of RF connectors.

14. An interface as recited in claim 1, wherein each of the plurality of floating brackets provides compliant movement along a plane normal to a Z-axis of the first portion of the test system.

15. An interface as recited in claim 14, wherein each of the plurality of floating brackets further provides compliant movement along the Z-axis of the first portion of the test system.

16. A method of forming connections between a first portion of a test system and a second portion of a test system, the first portion of the test system including floating brackets individually and compliantly attached to the first portion of the test system and each floating bracket including blind-mate connectors for attaching to complementary blind-mate connectors on the second portion of the test system, the method comprising:
placing the first portion of the test system in coarse alignment with the second portion of the test system; and
compressing together the first and second portions of the test system to individually align each of the floating brackets of the first portion of the test system with the second portion of the test system and to mate the blind-mate connectors of the first portion of the test system with the complementary blind-mate connectors of the second portion of the test system.

17. A method as recited in claim 16, wherein one of the first and second portions of the test system is a device interface board for connecting to devices under test, the method further comprising testing at least one device under test using the test system.

18. An interface for making blind-mate connections between different portions of a test system, comprising:
a test head;
a device interface board;
a plurality of floating brackets each individually and compliantly attached to one of the test head and the device interface board and each including a plurality of blind-mate connectors;
a plurality of mating brackets each coupled to the other of the test head and the device interface board and including a plurality of complementary blind-mate connectors,
wherein each of the plurality of floating brackets is compliantly moveable to align with one of the plurality of mating brackets, for making electrical connections between each plurality of blind-mate connectors and each plurality of complementary blind-mate connectors.

19. An interface as recited in claim 18,
wherein each of the plurality of floating brackets is mechanically coupled to a support via at least one cylindrical fastener that extends into the support through a hole in the floating bracket, and
wherein the hole in the floating bracket has a diameter that is greater than the diameter of the cylindrical fastener to allow the floating bracket to move in horizontal compliance with respect to the support.

20. An interface as recited in claim 19,
wherein at least one spring biases the floating bracket in an upward position of a range of travel to allow the floating bracket to move in vertical compliance with respect to the support.

21. An interface as recited in claim 18, wherein at least one of the plurality of blind-mate connectors conveys electrical signals used to perform digital testing on devices under test.
